(19) United States
(12) Patent Application Publication
(10) Pub. No.: US 2010/0043285 A1
(43) Pub. Date: Feb. 25, 2010

(54) Apparatus and Method for Covering Surfaces with a Planting Module

(76) Inventor: Charles F. Kelty, Santa Fe, NM (US)

Correspondence Address: PEACOCK MYERS, P.C., 201 THIRD STREET, N.W., SUITE 1340, ALBUQUERQUE, NM, 87102, US

(21) Appl. No.: 12/505,416

(22) Filed: Jul. 17, 2009

Related U.S. Application Data
(60) Provisional application No. 61/081,629, filed on Jul. 17, 2008.

(51) Int. Cl. A01G 9/02; A01G 25/00

(52) U.S. Cl. 47/81; 47/86

(57) ABSTRACT

A planting surface that is disposed on a lid, a cover, a roof, a yard, a wall, a pond, lake, container or other surface. The present invention comprises an apparatus and method comprising a modular tray or reservoir in which is disposed a planting matrix and a planting medium. The invention is particularly useful for green roof applications.

### CROSS-REFERENCE TO RELATED APPLICATIONS

This application is a continuation-In-part application of U.S. Provisional Application Ser. No. 61/081,629, entitled “Green Paver, Tile, Lid, Cover or Module”, to Charles F. Kelty, filed on Jul. 17, 2008, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to methods and apparatuses for creating a plant or garden-supporting surface comprising a “green” paver, tile, lid, cover or module, that is lightweight, modular, and flexibly arranged.

2. Description of Related Art

Currently, there is a need for improving the quality of life in urban environments by improving air quality, mitigating the effects of heat islands caused by ever increasing development, improving energy efficiency, and improving aesthetics by adding plants to roofs. However, the weight of the soil needed for planting and maintaining plants, gardens, and trees is prohibitive.

Additionally, in conventional gardens, approximately 5% to 8% of water is lost to aspiration and approximately 80% to 90% is lost to evaporation or seepage.

There is a need for a “green” support apparatus and method that supports plant growth with minimal water usage, and that is modular, low-cost, lightweight, and can be placed on a wide variety of surfaces.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1A and 1B are illustrations of an embodiment of a garden-supporting surface of the present invention comprising a lid cover for a filter box;

FIG. 2 illustrates a top view of the lid cover of FIG. 1;

FIGS. 3A-3E illustrate embodiments of a lid cover of the present invention with various handles;

FIGS. 4A and 4B illustrate cutaway side views of the lid cover of FIG. 1 with fluid uptake tubes;

FIG. 5 illustrates an embodiment of the present invention comprising a surface-covering module;

FIGS. 6A-6E illustrate various shapes of modules of the present invention disposed adjacent to each other;

FIGS. 7A and 7B illustrate cutaway side views of modules of the present invention;

FIGS. 8A and 8B illustrate modules of the present invention with water flow, plantings and a load grate;

FIGS. 9A and 9B illustrate side views of modules of the present invention shown disposed on a surface at different grade angles to the horizontal;

FIGS. 10A and 10B illustrate side views of an embodiment of a module of the present invention with reservoir sides having draft angles;

FIGS. 10C-10E illustrate landscape embodiments of the modules of the present invention.

FIGS. 11A and 11B illustrate side views of modules of the present invention fastened to a roof or other surface;

FIGS. 12A-12E illustrate an interlock grommet to fasten modules together and allow for fluid communication;

FIGS. 13A and 13B illustrate a sliding dovetail interlock to fasten modules of the present invention;

FIGS. 14A-14C illustrate interlocks to fasten modules of the present invention;

FIGS. 15A and 15B illustrate modules fastened to a roof with an overhang interlock;

FIGS. 16A and 16B illustrate modules fastened to a roof with a slurry interlock;

FIGS. 17A and 17B illustrate modules fastened to a roof with a slurry interlock weight;

FIGS. 18A and 18B illustrate a side wall cutaway view;

FIG. 19 is an illustration of a valve-box-covering lid of the present invention;

FIGS. 20A-20G are illustrations of a plug and plug tool of the present invention;

FIGS. 21A-21C are illustrations of a skimmer extender of the present invention;

FIGS. 22A-22C are illustrations of a prior art skimmer extender; and

FIGS. 23A-23C are illustrations of a planting pot or container of the present invention.

Deleted.

### BRIEF SUMMARY OF THE INVENTION

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

An embodiment of the present invention comprises a surface-covering planting module for at least one plant comprising at least one planting reservoir comprising a bottom, a sidewall, a planting matrix comprising a lightweight material providing structure for plant root growth, and a planting medium comprising an organic material and an inorganic material comprising a capillary conducive medium.

The module may further comprise at least one tube connecting at least one planting reservoir to a water source. A screen may be disposed in the tube. The module may further comprise a lower reservoir grid disposed in the reservoir and the reservoir grid may be removable. The module may comprise a planting reservoir comprising compartments.

An embodiment of the present invention comprises a module where water is wicked from a lower portion of the reservoir up through a planting medium and into wicking channels between the compartments of the reservoir grid and to plants on the surface.

The module may further comprise a secondary reservoir grid disposed on the lower reservoir grid. The lower reservoir grid may be removable. The module may comprise a sidewall comprising at least one drainage opening. The module may comprise a hydroponic plug. The module may comprise an elevating support disposed on a surface. The module may comprise an interlock for attaching to additional modules and a fastener for attaching the module to a structure. Adjacent modules may comprise shapes including but not limited to a circle, a triangle, a square, a rectangle, an oval, an octagon, or a hexagon.

The module comprising a planting matrix may comprise at least one removable plug. The removable plug is disposed in the planting medium.

The module may comprise an angled side for flexible arrangement on an angled surface. The module may be disposed adjacent to at least one additional module.

The lightweight material may be fibrous and/or porous and/or non-woven and/or lofty material. The inorganic material may comprise foam. The foam may comprise an open-cell foam. The organic material may comprise a material, including, but not limited to peat moss, humus, or soil.

An embodiment of the present module comprises a method of covering a surface with a plant comprising providing at least one planting reservoir or module (these terms are sometimes used interchangeably herein) comprising a bottom, a sidewall, a planting matrix comprising a lightweight material providing structure for plant root growth, a planting medium comprising an organic material and an inorganic material comprising a capillary conducive medium, and growing the plant in the reservoir.

The method may further comprise one or more of the following steps: connecting the reservoir to a water source; disposing a lower reservoir grid in the reservoir; removably disposing a secondary grid on the lower reservoir grid; disposing the planting reservoir on a slanted surface; draining water through a drainage hole disposed in the sidewall; disposing planting reservoirs adjacently; and interlocking the planting reservoir to an adjacent planting reservoir; and/or water flow between adjacent planting reservoirs.

The method may further comprise disposing a planting reservoir adjacent to an additional planting reservoir and interlocking the planting reservoirs. The planting reservoir may comprise any of a number of shapes, including but not limited to a circle, a triangle, a square, a rectangle, an oval, an octagon, or a hexagon.

The method may further comprise disposing a planting reservoir on a roof, a lid, a ground surface, a walking surface, a planter or a wall.

### DETAILED DESCRIPTION OF THE INVENTION

The present invention comprises a planting modular or reservoir that is disposed on a lid, a cover, a roof, a yard, a wall, a pond, lake, container, ground surface, walking surface, planter or any other surface. The present invention comprises an apparatus preferably comprising a modular tray in which is disposed a planting matrix and a planting medium. The planting matrix preferably comprises a lightweight, porous, fibrous, non-woven, lofty material (including but not limited to an organic-coir or recycled inorganic material) material that provides structure for root growth and additives for mineral and nutrient support. The planting medium preferably comprises an organic material, including but not limited to peat moss, humus, or soil and an inorganic material comprising a capillary conducive medium, including but not limited to open cell foam and peat moss, that encapsulates soil and minerals. Any hydroponic materials may be used in accordance with the present invention. For larger surfaces, the modules preferably comprise a shape capable of being disposed adjacent each other and further alternatively interlocking the modules together, including but not limited to a hexagon, rectangle, square, circle or oval shape, although any shape may be utilized in accordance with the present invention. Each module preferably covers a surface area of between three (3) square feet and fifteen (15) square feet, although any size may be made and utilized in accordance with the present invention.

The present invention provides hydroponic-type growing versatility and preferably reduces water loss. The present invention may comprise non-xeriscape or xeriscape plant types, yet compares favorably to xeriscaping for reduced water use, wherein plants need to be watered minimally, even in hot, arid environments. The hydroponic environment and soil-containing substrate of the present invention holds water to eliminate uncontrolled seepage for extended periods and reduces evaporation, because the water is not directly exposed to the atmosphere.

The present invention reduces urban heat island effects, enhances storm water run-off management, adds valuable/useable space providing economic benefits, is energy efficient year-round, and purifies air and water. The present invention may be used in poor soil or no soil conditions, including on pavement, asphalt and rooftops and other building surfaces.

The modules of the present invention may comprise topologically interacting shapes, including but not limited to squares, rectangles or hexagons, and are used to cover a surface. Modules may be transported indoors or outdoors easily, and can accommodate an overflow integrated with a roof or storm management overflow. Modules are interchangeable and may be changed to create various designer garden patterns. Modules may contain seasonal type plants that can be changed as the seasons change.

The present invention provides a planting surface useful for balconies, patios, flat or pitched roofs, walls, fixed or portable planters or containers, lids, pavers, tiles, modules, covers, or any other surface. The present invention comprises a “green lid,” a “green lawn,” or a “green roof” for plantings or a garden. The terms “cover,” “tray,” “lid,” “paver,” “tile,” “module” and sometimes “reservoir” are used interchangeably in the specification and claims. They are all intended to mean a module for growing plants or providing a “green” surface. In addition, “green” refers to any artificial grass, artificial turf, synthetic material or other aesthetic material that creates an aesthetic or visual impression. Such materials may be used, particularly, for lids and covers in the present invention.

Preferred embodiments of the present invention are illustrated in the drawings.

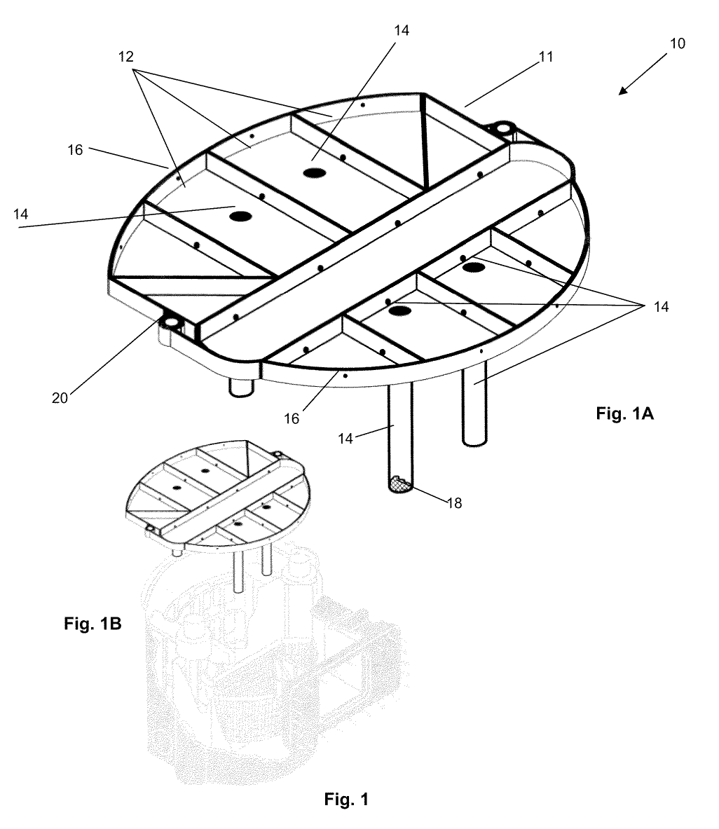

One embodiment of the present invention comprising a cover disposed on a lid is illustrated in FIG. 1. Such a lid is useful for a skimmer, such as disclosed in U.S. Pat. No. 7,052,612. However, the lid is not limited to skimmers but may be used for any other lid or cover that might support a planted surface.

FIG. 1A illustrates lid or cover 10, which comprises compartmentalized planting reservoirs 12 (which have a planting medium and a planting matrix, shown in other Figures.), sides 11 of any height, tubes 14 to channel water from a body of water to reservoirs 12, drainage holes 16 to allow excess water to flow out of reservoirs 12, and screen mesh 18 to filter water in tubes 14. The planting medium and planting matrix are disposed in reservoirs 12, and plants are planted therein. Water wicks up to and remains in compartmentalized planting reservoirs 12 to water the plants.

Drainage holes 16 disposed in the perimeter of sides 11 serve as a lid overflow mechanism to dispose of excess water in compartmentalized planting reservoirs 12. Tubes 14 may comprise pipes or tubes (including but not limited to circular, square, rectangular, oval, etc., cross sections) that extend downward from lid cover 10 into a water source (e.g. a skimmer or pond).

FIG. 1B illustrates cover 10 disposed on and camouflaging a pond skimmer apparatus (shown in shadow). Cover 10 may be disposed on or atop a pond skimmer apparatus by being seated on or fitted to the apparatus, or by fasteners disposed in fastener openings 20. A cover may be disposed on any other structure or apparatus where a “green” surface is desired.

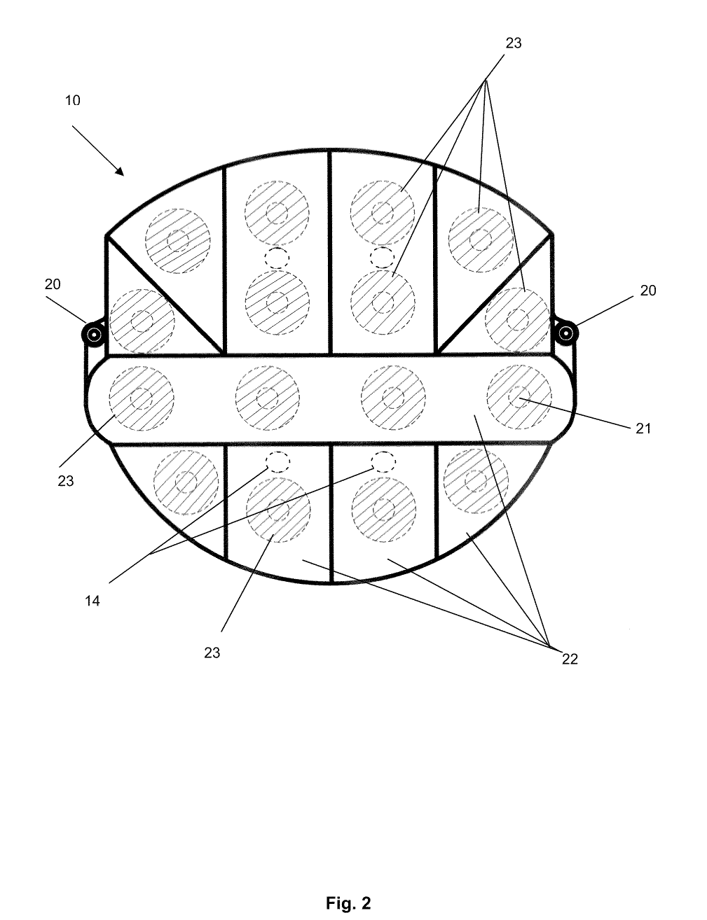

FIG. 2 illustrates a top view of lid cover 10 comprising removable plugs 23 with surrounding matrix 22 disposed in reservoirs 12. Plugs 23 are preferably disposed adjacent tubes 14. Preferably, plugs 23 are made of fabric, foam or other loose material (e.g. non-woven polyester fabric) preferably with a diameter of between approximately 1″ and 8,″ more preferably between approximately 2″ and 7″ and most preferably between approximately 3″ and 6″. Plug 23 is preferably circular in shape but can alternately comprise any shape (including but not limited to a square, rectangle, hexagon, etc.)

Plugs 23 may be cut or scored in matrix 22 so that they may be easily lifted out of or removed from matrix 22. Plugs 23 are removed from surrounding matrix 22 to allow for planting plugs (having plant(s)) to be disposed in the resulting openings). The planting plugs may be disposed above wicking channels 21.

Subsequent figures herein show the relationship of the planting plugs, the planting matrix, the planting medium, wicking channels and tubes. Planting plugs are preferably available, retail or wholesale, where plants useful in accordance with the present invention can be purchased. Alternatively, planting plugs can be made on-site. High-production growers can produce and sell planting plugs. Plants (e.g. bare root plants) may be provided in bonded, organic (e.g. one-half) media soil planting plugs that easily insert into the plug holes of the present invention.

A typical pond skimmer lid is approximately 8″ to 10″ above the water surface. Tubes 14 serve to bring water up into reservoirs 12. The bottom section of tube 14 is preferably screened 18 (see FIG. 1). Water travels upward through tubes 14 preferably by capillary action. However, other means of transporting the water to reservoirs 12 may also be used, including but not limited to by pumping, or by air lift. The water from tubes 14 continues upward through wicking channels 21 by capillary action. Wicking channels 21 are preferably filled with hydrophilic planting medium.

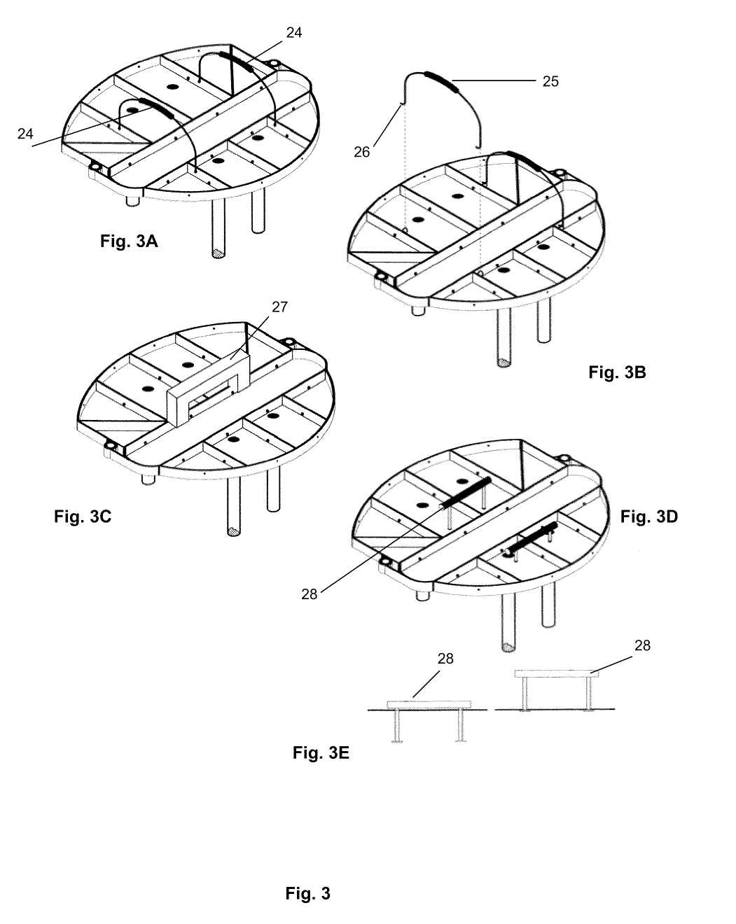

FIG. 3 illustrates an embodiment of cover 10 comprising various handles. FIG. 3A illustrates handles 24 attached to cover 10. FIG. 3B illustrates handles 25 comprising hooks 26 removably attached to cover 10. FIG. 3C illustrates molded handle 27 attached to cover 10. FIG. 3D illustrates drop-down handle 28 attached to cover 10. FIG. 3E is a side view of drop-down handle 28. Handles can be hidden in the grass or plants or folded to one or more sides. Other types of handles or lifting mechanisms can also be used in accordance with the present invention.

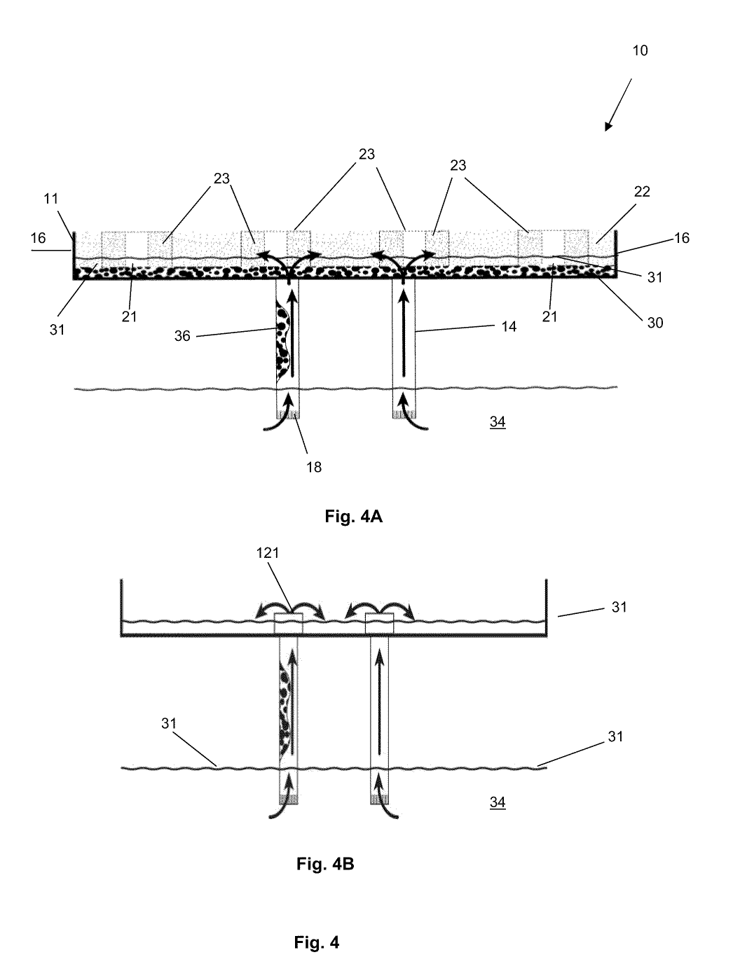

FIG. 4 illustrates a cutaway side view of module 10. FIG. 4A illustrates module 10 comprising sides 11 and removable plugs 23 in surrounding planting medium 30. Tubes 14 are inserted into water 34, such as an ornamental pond, pool, or basin.

Planting medium 30 preferably comprises organic and inorganic material comprising peat moss and open cell foam, including but not limited to Flexi-Mix™. Other materials may also be used for the planting medium of the present invention.

Fewer organics involved in hydroponics result in a more chemically stable and oxygen-rich environment that is preferable for plants. The inorganic material (e.g. open cell foam) is much lighter than soil and thus is easier to transport and safer to dispose on roofs and other load-bearing surfaces. It also facilitates strong capillary uptake.

Matrix 22 is preferably made from recycled plastic or organic fiber coir that creates an open environment for plant root growth and gas exchange, and can function as a pseudo-hydroponic environment. Matrix 22 is preferably a dry, open environment. Many types of materials may be used for the matrix.

Hydroponic plugs 36 comprising hydrophilic or other type of foam (including but not limited to polyurethane), preferably encapsulating peat moss or other organic material, are disposed and inserted in tubes 14 to flow of water, from water 34 upward (see arrows) through tubes 14 and into planting medium 30, wicking channels 21, and planting matrix 22. Screen 18 is preferably disposed at the end of tubes 14 to filter water and particulate. Hydroponic planting plugs comprising a loose media or bonded plug are disposed in planting matrix 22 where plugs 23 have been removed. Wicking channels 21 are disposed throughout the planting matrix 22 to bring water to the surface of the module. Wicking channels 21 can be any cross-sectional shape. Overflow passage (at 16) is disposed in side 11 to keep the water level constant in the reservoir.

FIG. 4B illustrates module 10 comprising tube risers 121 raised above water level 31 for drainage of reserved water.

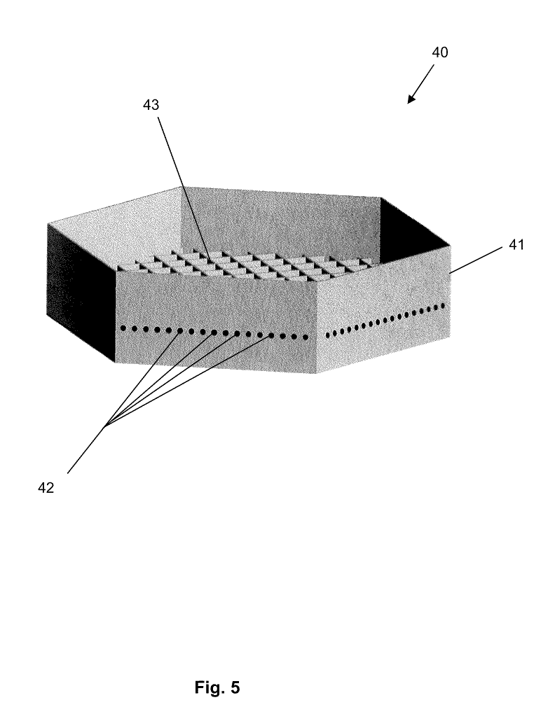

FIG. 5 illustrates an embodiment of the present invention comprising surface-covering module 40 comprising sides 41 of any height, drainage or overflow holes 42, and planting grid compartmentalized reservoirs 43. Module 40 preferably comprises dimensions that enable efficient and inexpensive stacking and shipping.

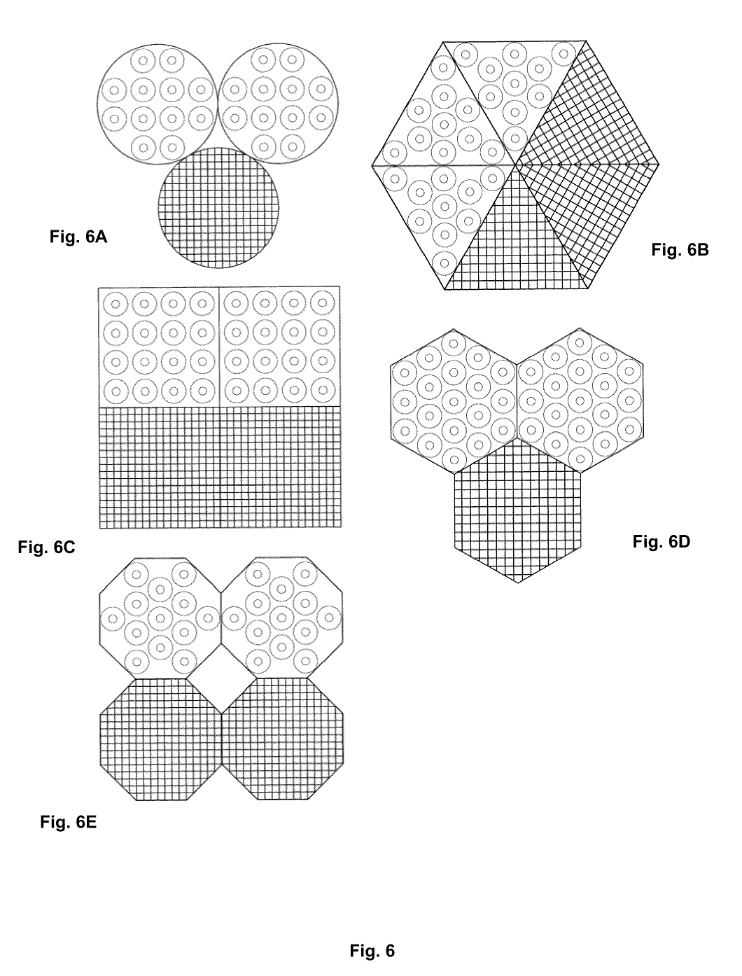

FIGS. 6A-6E illustrate modules in various shapes and disposed adjacent to each other. Modules are preferably topologically-interacting or interlocking. Modules may be of any shapes, including but not limited to circles, triangles, squares, rectangles, squares, ovals, hexagons, octagons, etc. FIG. 6A illustrates circular modules disposed adjacent to each other. FIG. 6B Illustrates triangular modules disposed adjacent to each other. FIG. 6C illustrates square modules disposed adjacent to each other. FIG. 6D illustrates hexagonal modules disposed adjacent to each other. FIG. 6E illustrates octagonal modules disposed adjacent to each other, with a central space. FIGS. 6A-6E show multiple interlocking modules. These modules are useful for extended surfaces (including but not limited to walkways, patios, gardens, roofs, etc.). Single modules (shown in other Figs.) may be utilized for single site locations (including but not limited to planters, ponds, lids, etc.). As can be appreciated by those skilled in the art, any shapes and arrangements may be utilized in the present invention.

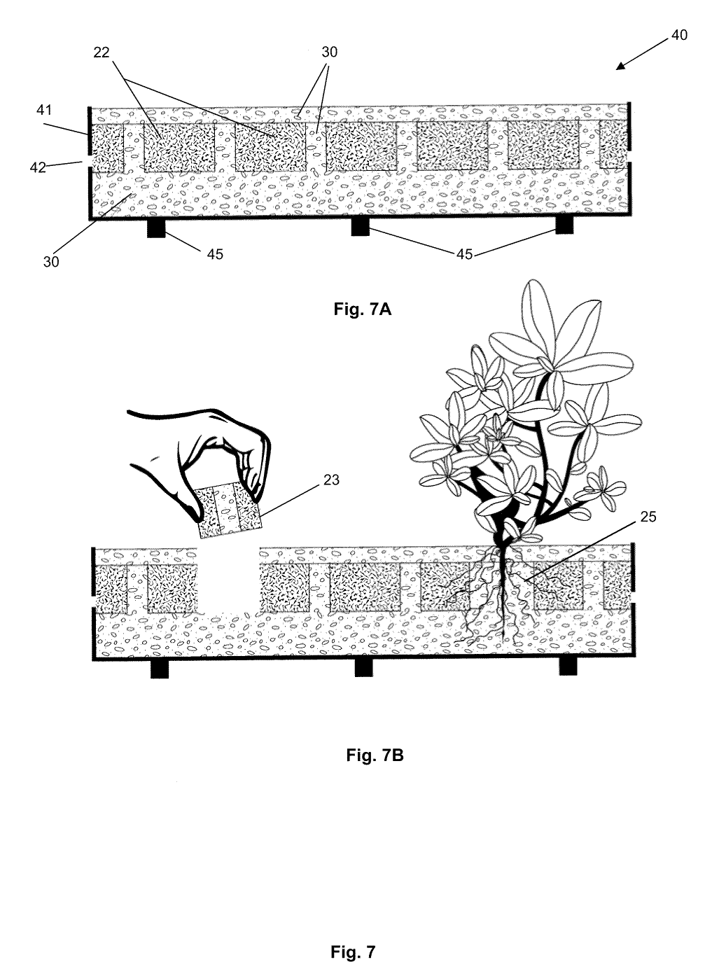

FIGS. 7A and 7B illustrate cutaway side views of an embodiment of the present invention comprising module 40. FIG. 7A illustrates module 40 comprising supports 45 that elevate module 40 off of a surface, including but not limited to a roof, flooring, or patio. Side 41 is of sufficient height to contain planting medium 30 and planting matrix 22. Drainage or overflow hole 42 allows excess water to be removed or to flow out. FIG. 7B illustrates plug 23 removed from module 40. Planting plug 25 is inserted into module 40 and supports numerous plants, including but not limited to grass, flowers, and even large plants such as shrubs or trees.

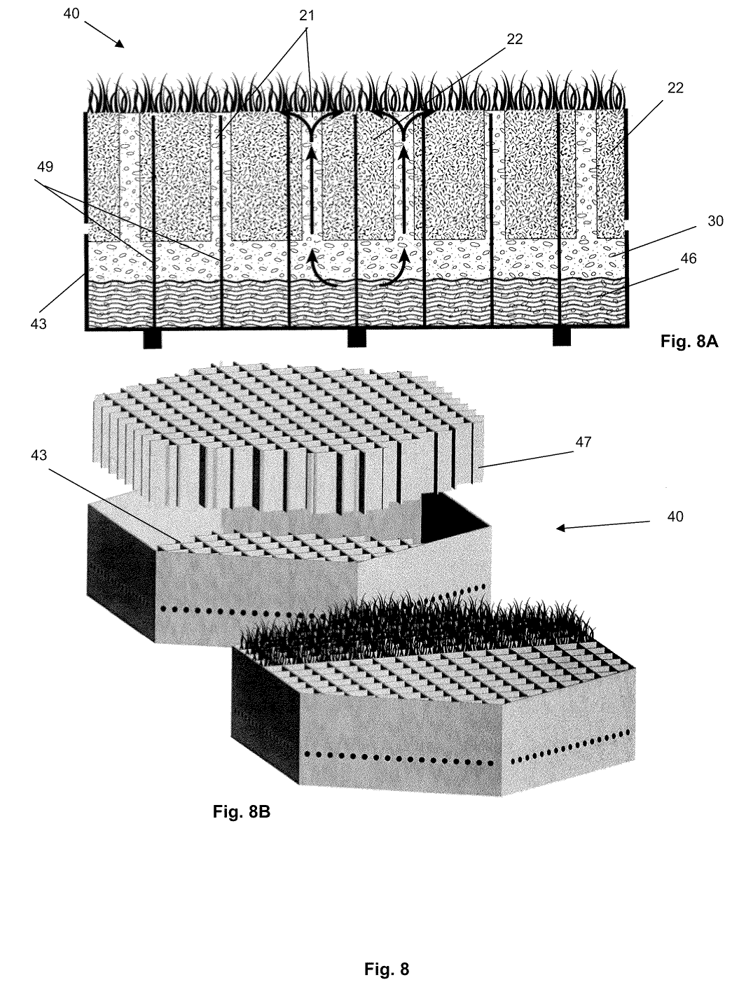

FIGS. 8A and 8B illustrate compartmentalized reservoir grids 43, 47 disposed in module 40. FIG. 8A illustrates grid or barrier sides 49 disposed in module 40 that separate water 46 into compartmentalized reservoirs. Either or both grids 43, 47 may be fixed or removable. FIG. 8A shows the wicking action (see arrows) of water 46 from a lower reservoir area 43, up through planting medium 30 and into wicking channels 21 between compartmentalized reservoir grid or barrier sides 49 and to the plants on the surface. A moist environment is created at the top of the planting plug surface utilizing planting matrix 22. An aerated environment is created by planting matrix 22. Roots of plants penetrate planting matrix 22 into planting medium 30. Plants also grow into and over the top of wicking channels 21. Plants easily cover both wicking channels 21 and planting matrix 22.

FIG. 8B illustrates optional secondary reservoir grid 47 disposed on lower reservoir grid 43 that bears the weight of planting medium 30 and, if desired, the weight of people or animals that walk or stand on top of module 40. In this embodiment, lower reservoir grid 43 may be integrally or removably disposed in module 40. Optional upper reservoir grid 47 is disposed on top of or in place of lower reservoir grid 43 in order to facilitate standing or walking on module 40.

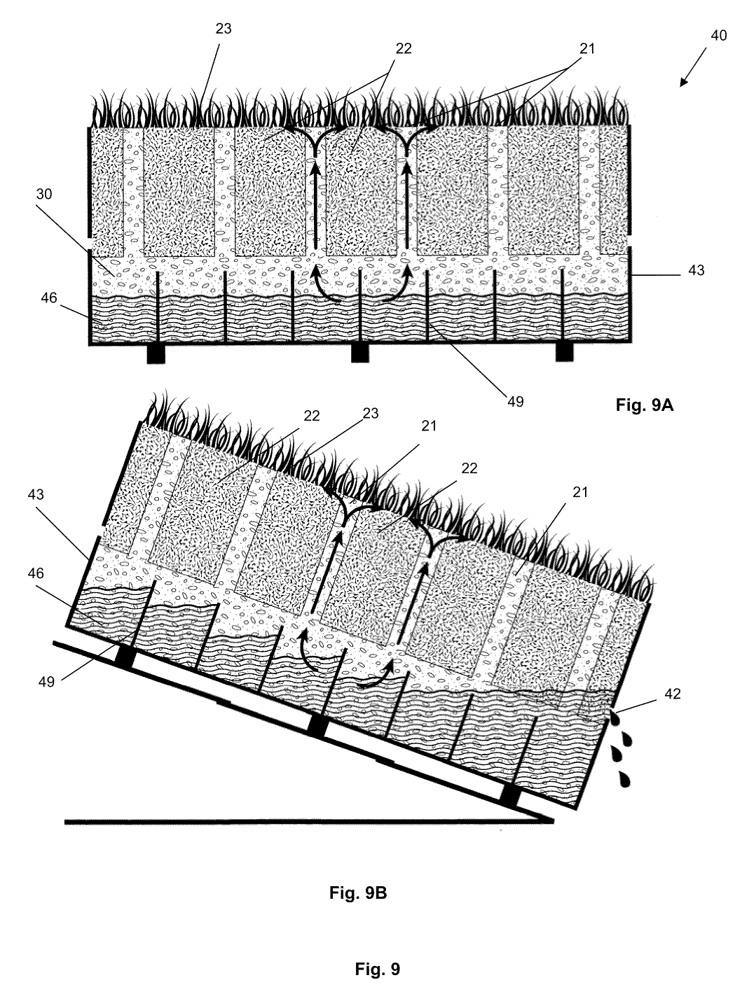

FIGS. 9A and 9B illustrate module 40 shown disposed on a surface at different grade angles to the horizontal. FIG. 9A shows a horizontal configuration (e.g. level ground or flat roof). FIG. 9B shows a slanted configuration (e.g. sloped roof or slanted ground area). FIG. 9A illustrates module 40 disposed on a flat surface comprising water reservoir 46 in compartmentalized lower reservoir area 43. FIG. 9B illustrates module 40 disposed on a tilted surface comprising water 46. Compartmentalized reservoir 43 has grid or barrier sides 49 to ensure that water is available to all wicking channels 21 (see arrows). Excess water is drained through drainage hole 42 on the lowest side. Drainage hole 42 ensures that roots will not rot as well as ensures that an optimal water level exists within module 40. Thus, module 40, when placed on pitched roofs or other slanted surfaces, ensures that plants will be supplied with water from the compartmentalized lower reservoir area 43.

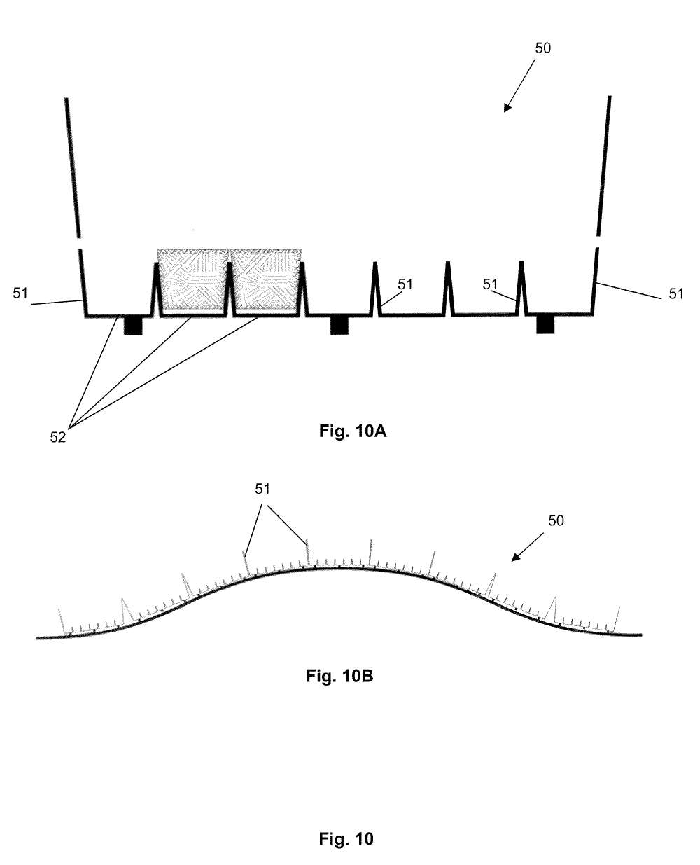

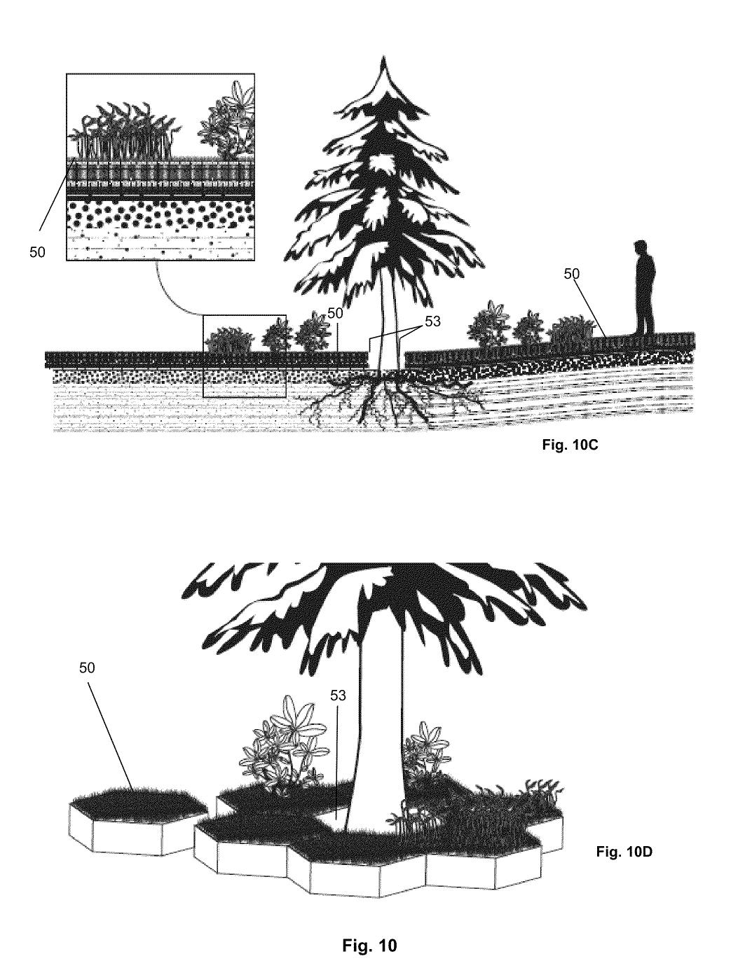

FIG. 10 illustrates an embodiment of the present invention comprising module 50. FIG. 10A illustrates a cutaway side view of module 50 with compartmentalized reservoir 52. Reservoir sides 51 comprise a draft angle incorporated into the side of reservoir 52 so that the opening of reservoir 52 is wider than its base. Draft angles allow for water, after freezing, to slide vertically upward instead of breaching reservoir 52 due to volume changes. FIG. 10A illustrates frozen water disposed in compartmentalized reservoir 52. As the water freezes, the solid ice will slide vertically upward along draft angle sides 51 and will not exert pressure horizontally on reservoir sides 51. FIG. 10B illustrates modules 50 disposed on an uneven surface (e.g. uneven ground), covering the surface. Because of slanted reservoir sides 51, module 50 has design flexibility to maintain interlock, or to accommodate and conform to uneven or even ground surface.

FIG. 10C illustrates modules 50 adjacently disposed on a landscaping surface, covering the surface as desired. Gaps 53 between interlocking adjacent modules 50 allow trees or other large plants to grow in any arrangement desired. Landscaping may be changed as desired, according to the change of seasons, changing uses, or changing aesthetics. FIG. 10D illustrates modules 50 disposed adjacent to a tree growing in gap 53. FIG. 10E illustrates a cutaway side view of modules 50 disposed adjacent to each other with foot 45 elevating module 50 off ground 55.

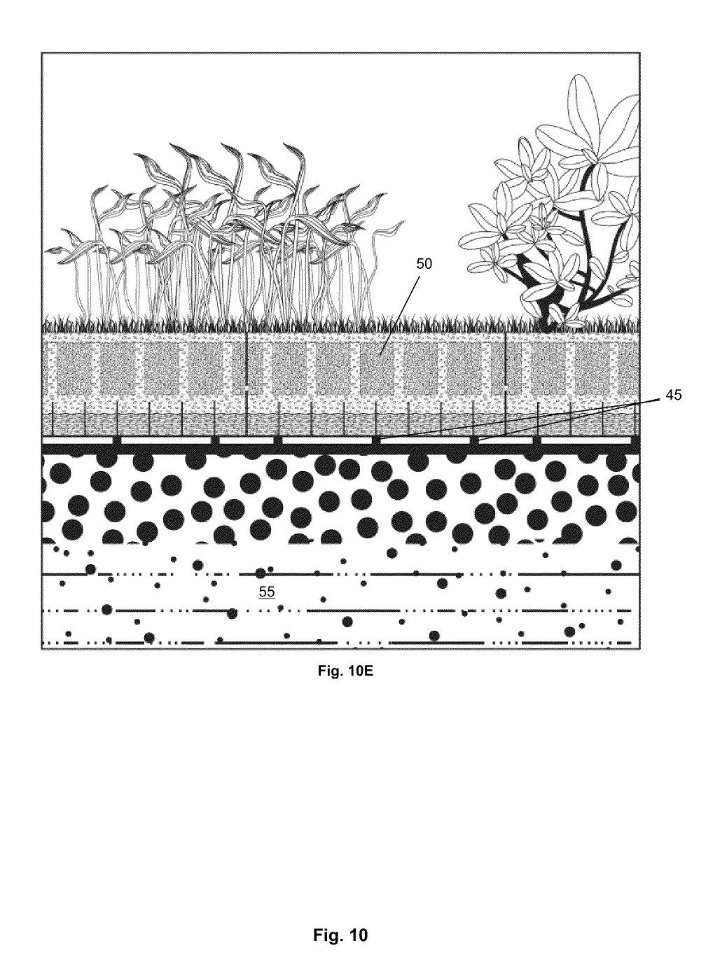

FIG. 11 illustrates a cutaway side view of module 40. FIG. 11A illustrates module 40 disposed on roof 60 or other mounting surface. Fastener or retaining member 66 is inserted through planting matrix 22 and planting medium 30 to insert into anchor 64 to attach module 40 to the surface. Fastener 67 is inserted into anchor sleeve 65 attached to anchor mount 64. Self-tapping screw threads 63 penetrate completely though anchor sleeve 65 and module 40 and fasten securely through roof mount gasket 62 preferably comprising a mastic. Feet 45 elevate module 40 from roof 60. Roof mount gasket 62 and gasket 61 secure fastener 67 in a water-tight manner to anchor sleeves 65 and 64 and to planting matrix 22. FIG. 11B illustrates a cutaway side view of module 40 comprising fasteners 66 and 67 covered by planting medium 30. The modules of the present invention minimize exposure of a roof or other surface to weather and thus protect the surface.

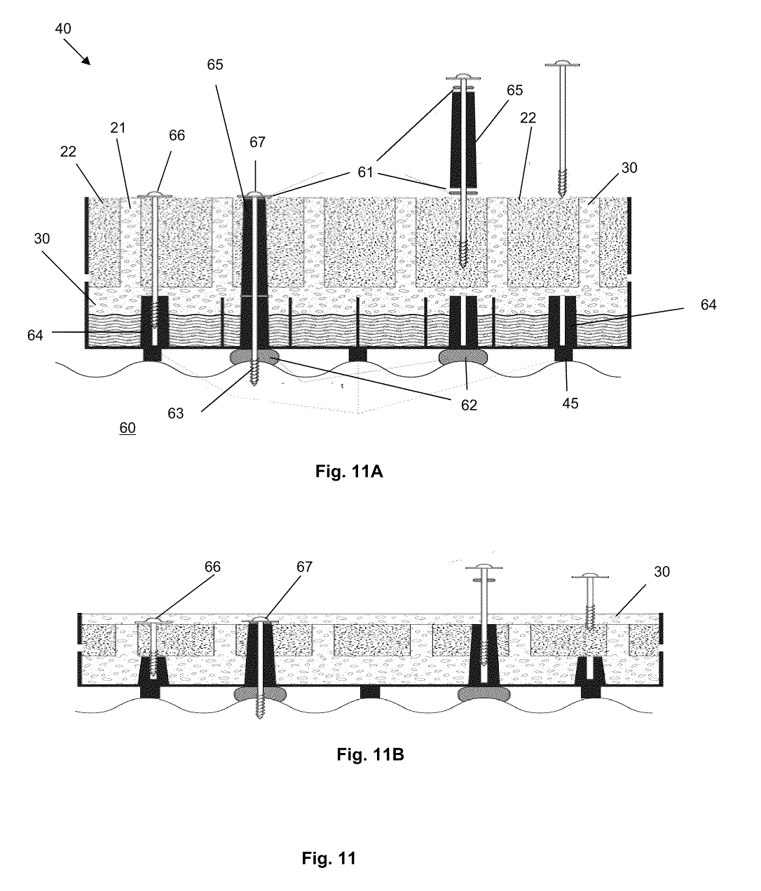

FIG. 12 illustrates interlocks useful for fastening or interlock modules together. FIG. 12A illustrates a side view of grommet interlock 70 comprising gasket 71, male portion 74, female portion 73, and screw threads 72. FIG. 12B illustrates a top view of grommet interlock 70. FIG. 12C illustrates a side cutaway view of grommet interlock 70 in a locked configuration with male portion 74 attached to female portion 73. FIG. 12D illustrates an a perspective view of grommet interlock 70. FIG. 12E illustrates grommet interlock 70 connecting adjacent modules 40 using reservoir hole 42. Interlock grommet 70 fits into reservoir hole 42 and allows water to flow freely between reservoirs in adjacent modules 40.

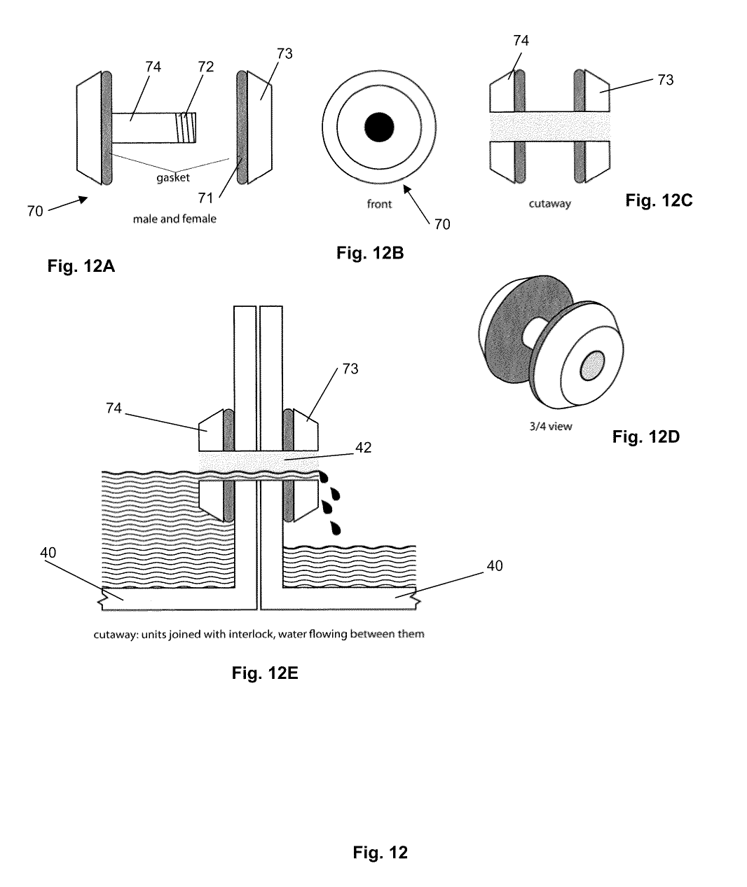

FIG. 13 illustrates modules fastened with interlocks. FIG. 13A illustrates a perspective view of modules 40 fastened with sliding dovetail interlock 80, FIG. 13B illustrates a top view of modules 40 fastened with sliding dovetail interlock 80.

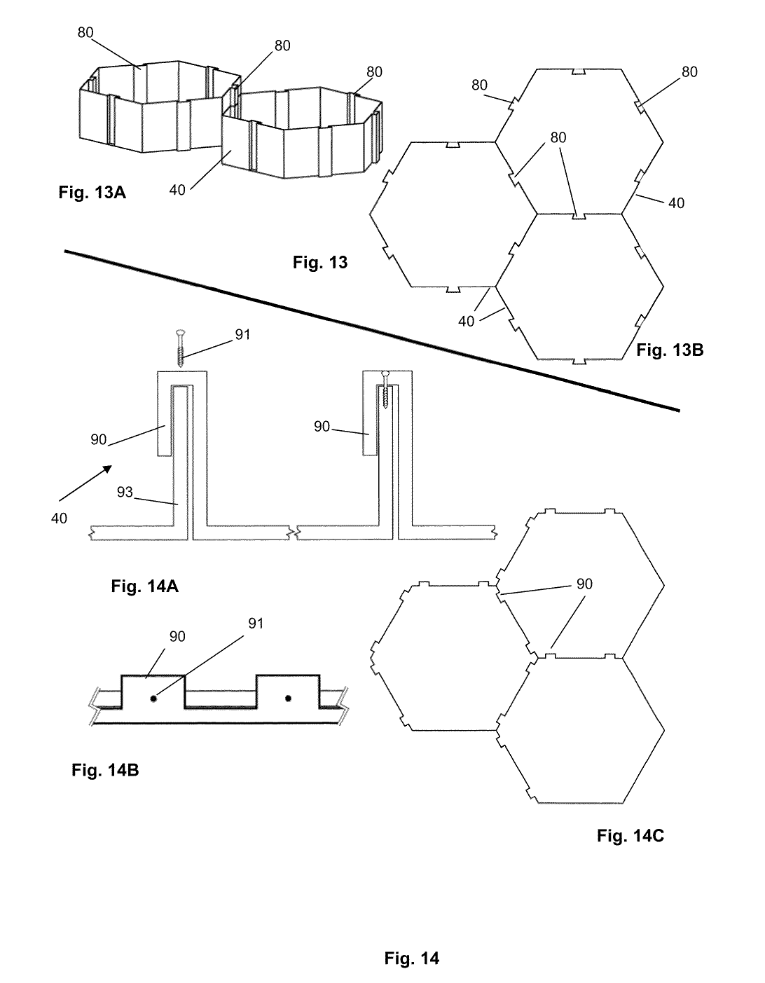

FIG. 14 illustrates modules fastened with interlocks. FIG. 14A illustrates modules 40 fastened with overhang interlock 90. Overhang interlock 90 is disposed over side 93 of module 40. FIG. 14B illustrates fastener 91 securely connecting overhang 90 to side 93 through a hole. FIG. 14C illustrates a top view of modules 40 secured by overhang interlock 90.

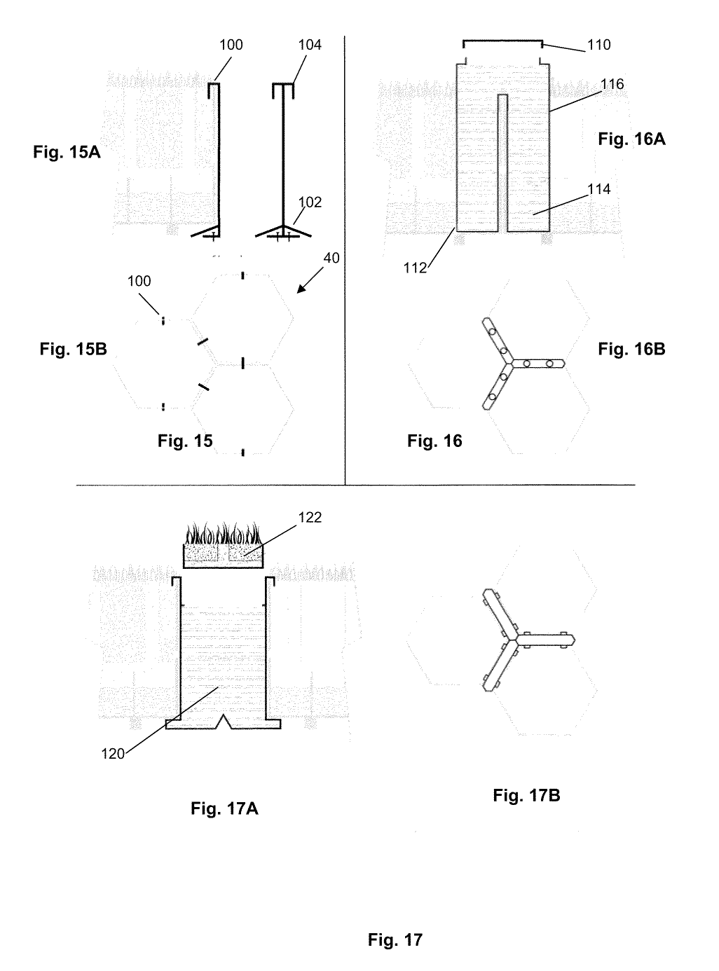

FIG. 15 illustrates modules fastened with interlocks. FIG. 15A illustrates bottom portion 102 of overhang interlock 100 mounted on the roof. Top portion 104 of overhang interlock 100 connects to the side of module 40. FIG. 15B illustrates a top view of modules 40 fastened to each other and the roof with overhang interlock 100.

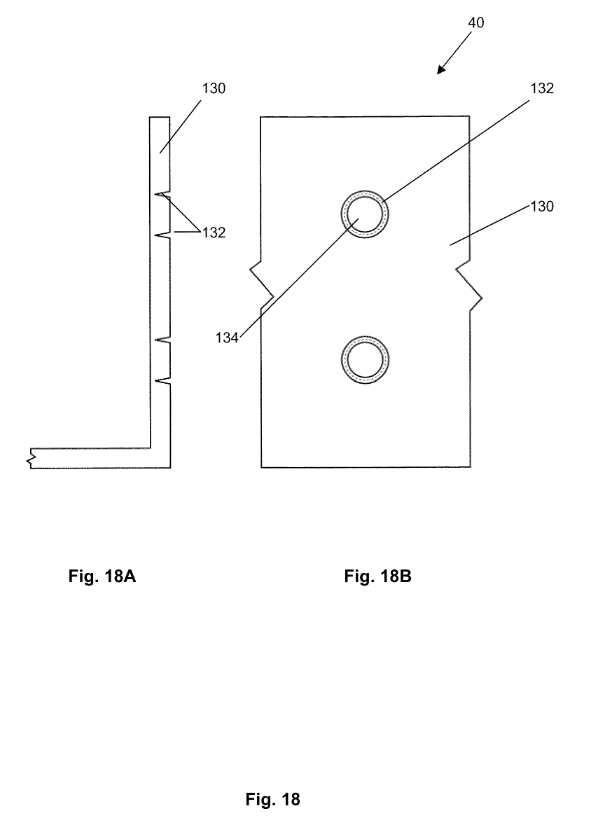

FIG. 16 illustrates modules fastened with interlocks. FIG. 15A illustrates bottom portion 112 of slurry interlock 110 filled with a fixing material (e.g. concrete 114) resting on the bottom of modules 40. Top portion saddle 116 of slurry interlock 110 bridges over sides of modules 40. FIG. 16B illustrates a top view of modules 40 fastened to each other. The saddle weight is greater than the lift capacity of the modules, therefore preventing the modules from lifting off of a roof, particularly in wind.

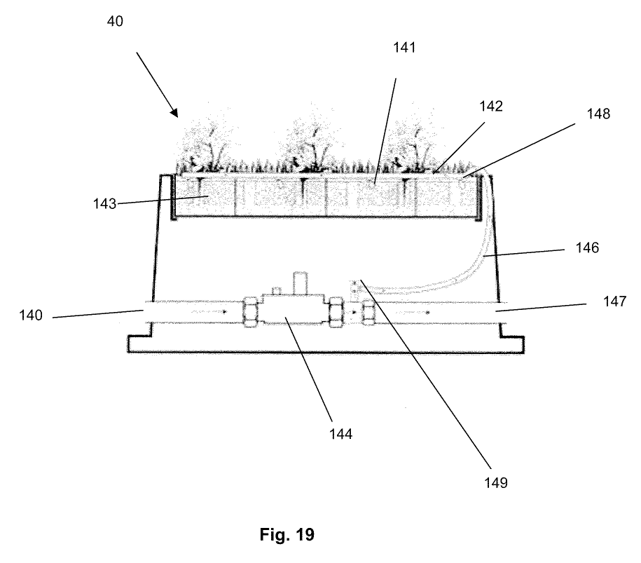

FIG. 17 illustrates modules fastened with interlocks. FIG. 17A is a side view of modules 40 interlocked and dually weighted with slurry interlock weight 120 thus using gravity for stability instead of fasteners. Planting lid 122 is disposed on slurry interlock weight 120 to improve aesthetics and add a planting surface. FIG. 17B is a top view of interlocked modules 40.

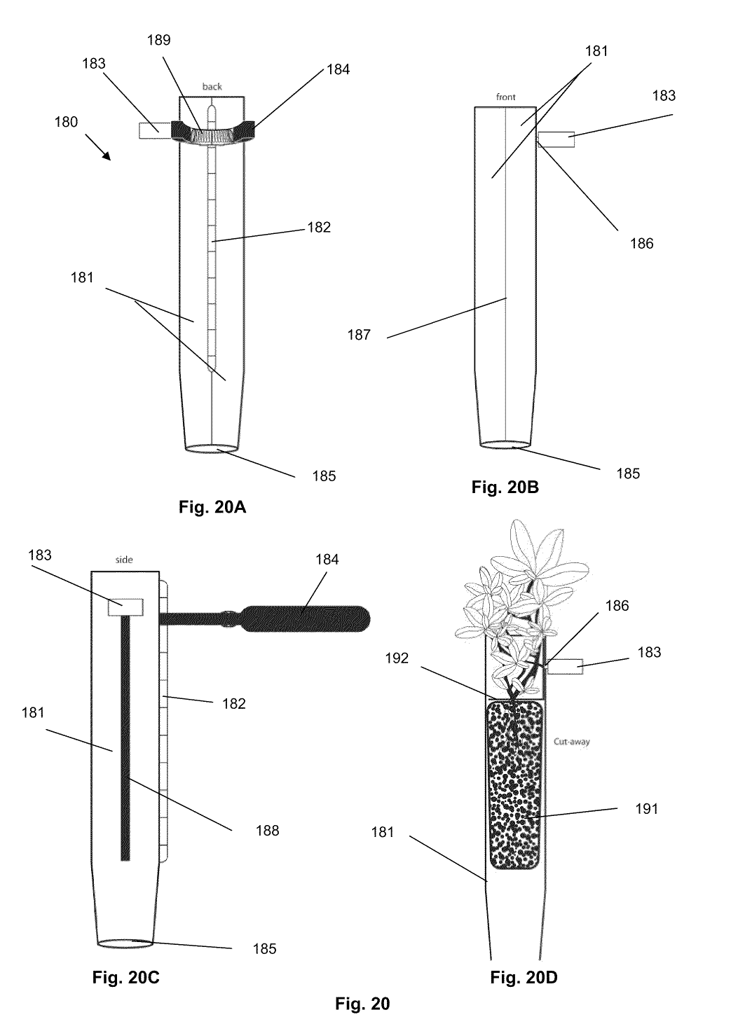

FIGS. 18A and 18B illustrate alternative side wall knockouts in module 40. Indentations 132 penetrate side wall 130 to a depth adequate to weaken side wall 130 sufficiently to enable a user to knock out an overflow opening 134. Indentations 132 provide optional levels depending on the desired reservoir level. New drainage holes can be added to the modules as needed. FIG. 18A is a side view and FIG. 18B is a front view of the side wall cutaway or knockout.

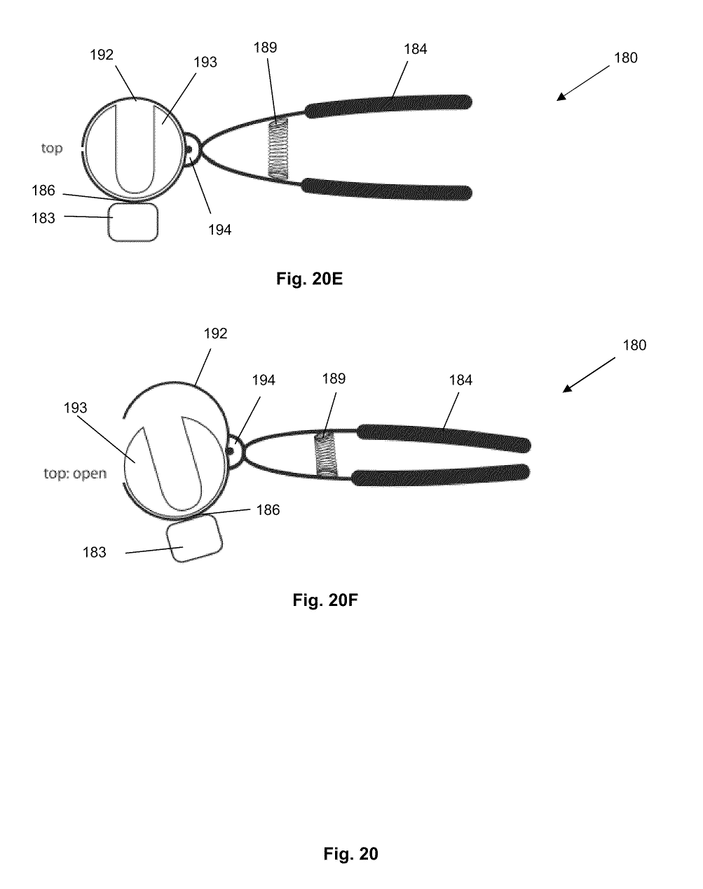

FIG. 19 is an illustration of cover lid 40 of the present invention, installed over an integrated valve box. Water feed 140 pipes water through valve box 144. Saddle valve 149 feeds water through feed tube 146 to connector tube 142. Emitter tips 148 emit water 141 into an integrated drip system that is disposed in cover lid 40. Water outlet 147 feeds water to sprinkler heads of an underground sprinkler system that is disposed elsewhere.

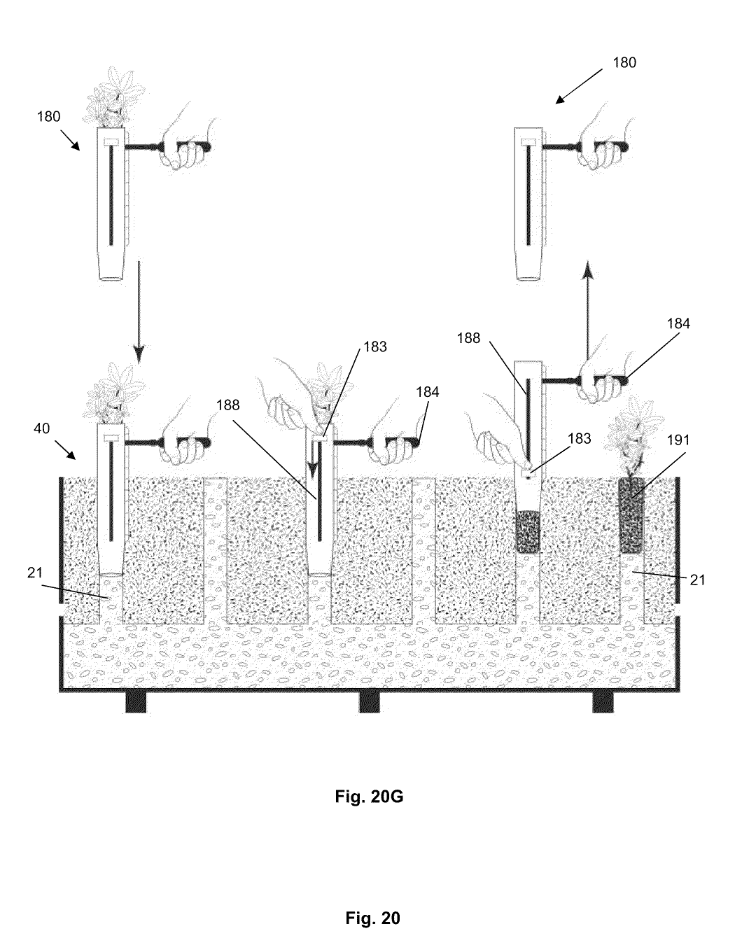

FIGS. 20A-20G illustrates plug tool 180 and the method of using plug tool 180. FIG. 20A is a back view of plug tool 180 comprising clamshells 181 comprising opening 185 and disposed on hinge 182, spring 189 disposed on handle 184, and tab 183. FIG. 20B is a front view of plug tool 180 comprising closed clamshells 181 comprising seam 187, opening 185, and tab 183 disposed on connector 186. FIG. 20C is a side view of plug tool 180 comprising closed clamshells 181 and tab 183 disposed in slot 188. FIG. 20D is a cutaway front view of plug tool 180 comprising closed clamshells 181. Tab 183 is disposed on connector 186 connecting to clamp 192. Clamp 192 is disposed adjacent to soil plug 191 (having a plant which is preferably purchased at a retail or wholesale level). FIG. 20E is a top view of plug tool 180 in a closed configuration comprising spring 189 connected to handle 184, and tab 183 disposed on connector 186 connecting to clamp 192. Inner plug holder 193 securely holds soil plug 191. Hinge 194 connects handle 184 to clamp 192. FIG. 20F is a top view of plug tool 180 in an open configuration wherein clamp 192 opens. Inner plug holder 193 securely holds soil plug 191. FIG. 20G illustrates using plug tool 180 to plant soil plug 191 in module 40 (view illustrations from left to right). Plug tool 180 containing soil plug 191 is inserted (see down arrow) in wicking channel 21. Tab 183 is depressed (see down arrow) along slot 188 while pushing downward on handle 184 to further insert plug tool 180 in wicking channel 21 disposed in module 40. Tab 183 is depressed to the end of slot 188 and subsequently handle 184 is pulled up (see up arrow) to remove plug tool 180 from wicking channel 21. Finally, plug tool 180 is completely removed from module 40 and is available to insert more soil plugs 191.

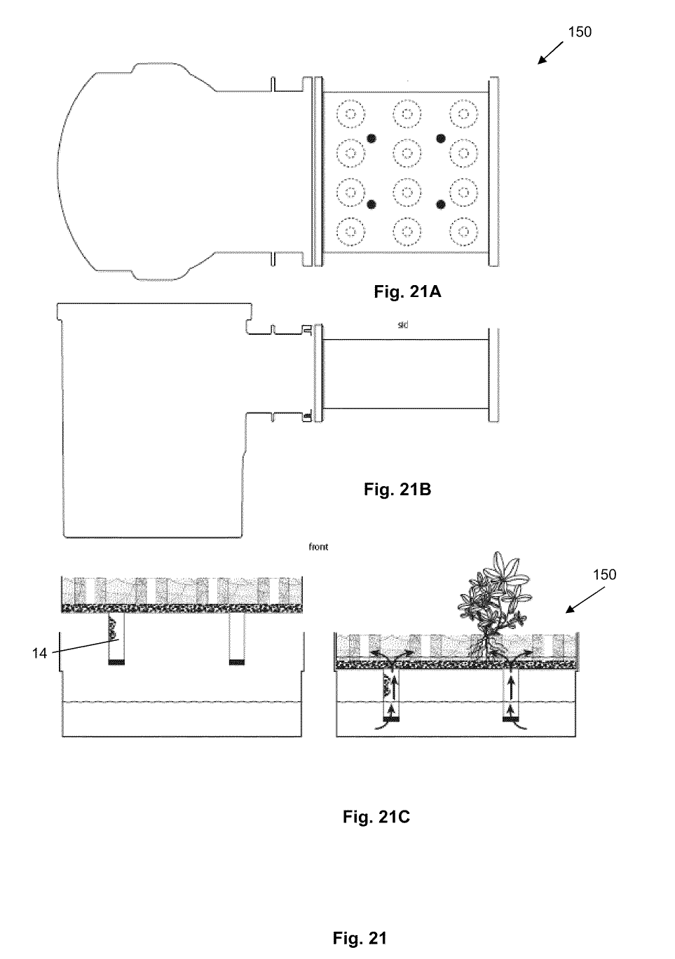

FIG. 21 is an illustration of a skimmer extension cover. FIG. 21A is a top view of skimmer extension cover 150 disposed on a skimmer extender neck. A skimmer extender keeps skimmer a greater distance, i.e. up to twenty (20) feet, from a pond or other body of water. Skimmer extension cover 150 is modular, can be walked upon, and can be lifted off for maintenance. FIG. 21B is a side view of skimmer extension cover 150 disposed on a skimmer extender neck. FIG. 21C is a front cutaway view of skimmer extension cover 150 disposed on a skimmer extender neck with tubes 14 disposed in the skimmer extender neck. As can be appreciated by those skilled in the art, the module, lid or cover of the present invention can be used to hide unsightly mechanical equipment.

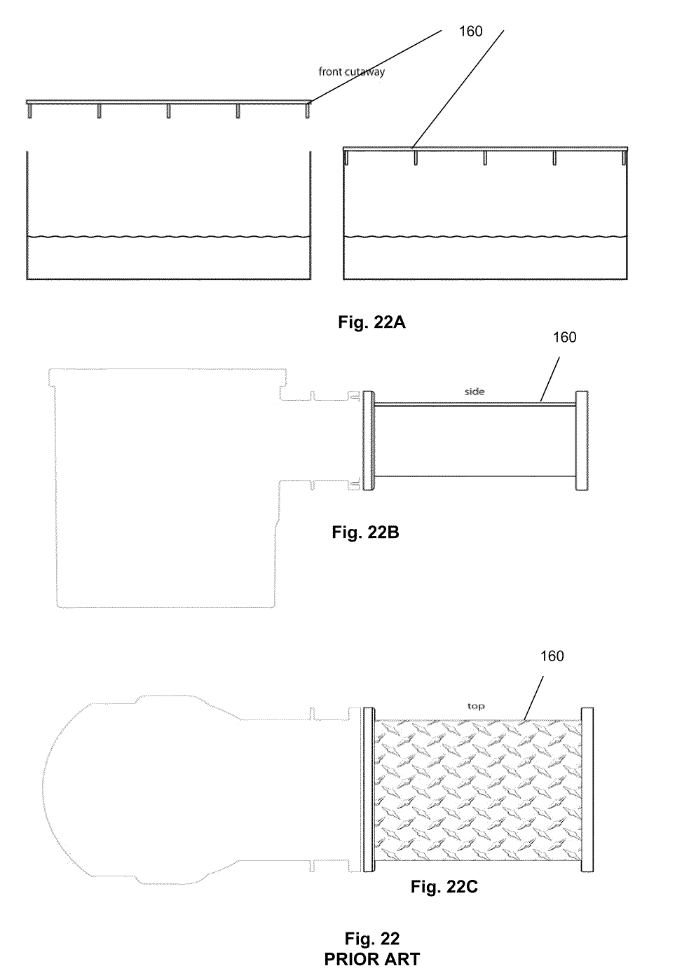

FIG. 22 is an illustration of prior art skimmer extension cover lid 160. FIG. 21A is a front cutaway view of standard skimmer extension cover lid 160 disposed on a skimmer extender neck. FIG. 21B is a side view of standard skimmer extension cover lid 160 disposed on a skimmer extender neck FIG. 21C is a top view of standard skimmer extension cover lid 160 disposed on a skimmer extender neck. As can be seen by comparing FIGS. 21 and 22, unsightly cover 160 can be replaced with cover 150 of the present invention to provide an aesthetic green surface.

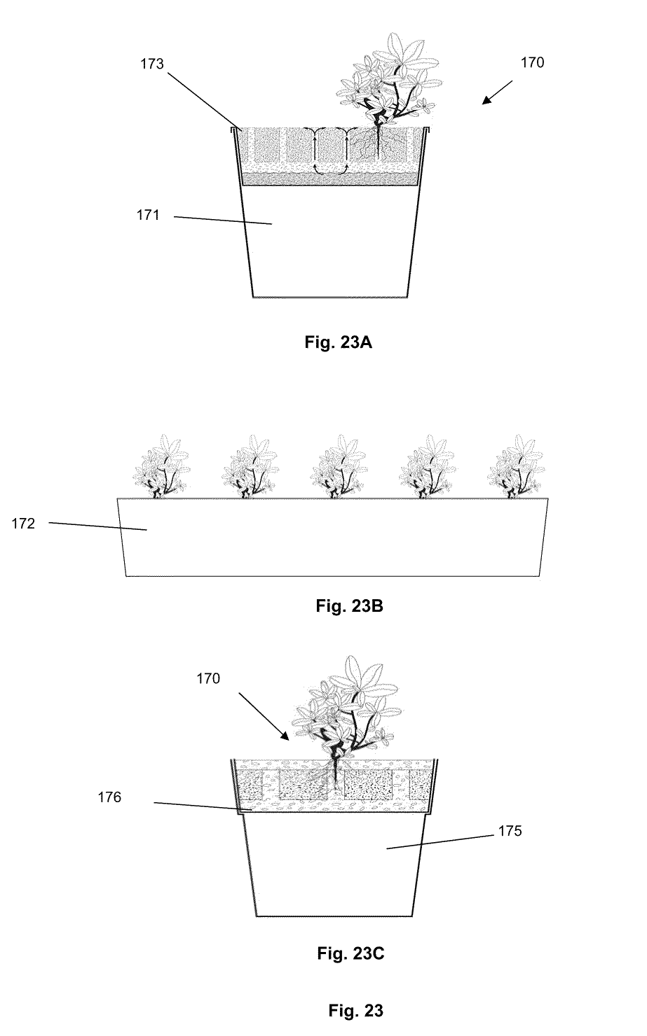

FIG. 23 is an illustration of a plant pot or container embodiment of the present invention. FIG. 23A illustrates module 170 disposed on plant pot 171 using hook 173. FIG. 23B illustrates module 170 disposed in plant window box 172. FIG. 23C illustrates module 170 disposed in plant pot 175 resting on ledge 176.

Deleted.

As can be appreciated by those skilled in the art, the present invention may be positioned on any surface, at any angle, and on flat or rolling or inconsistent surfaces. Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated herein by reference.

What is claimed is:

1. A surface-covering planting module for at least one plant comprising:
at least one planting reservoir comprising:
a bottom;
a sidewall;
a planting matrix comprising a lightweight material providing structure for plant root growth; and
a planting medium comprising an organic material and an inorganic material comprising a capillary conducive medium.

2. The module of claim 1 further comprising at least one tube connecting said at least one planting reservoir to a water source.

3. The module of claim 2 further comprising a screen disposed in said at least one tube.

4. The module of claim 1 further comprising a lower reservoir grid disposed in said reservoir.

5. The module of claim 4 wherein said at least one reservoir grid is removable.

6. The module of claim 1 wherein said planting reservoir comprises compartments.

7. The module of claim 6 wherein water is wicked from a lower portion of said reservoir up through a planting medium and into wicking channels between said compartments of said reservoir grid and to plants on the surface.

8. The module of claim 4 further comprising a secondary reservoir grid disposed on said lower reservoir grid.

9. The module of claim 8 wherein said secondary reservoir grid is removable.

10. The module of claim 1 wherein said sidewall comprises at least one drainage opening.

11. The module of claim 1 further comprising a hydroponic plug.

12. The module of claim 1 further comprising an elevating support disposed on a surface.

13. The module of claim 1 further comprising an interlock for attaching to additional said modules.

14. The module of claim 1 further comprising a fastener for attaching said module to a structure.

15. The module of claim 1 wherein said planting matrix comprises at least one removable plug.

16. The module of claim 15 wherein said removable plug is disposed in said planting medium.

17. The module of claim 1 wherein said planting reservoir comprises an angled side for flexible arrangement on an angled surface.

18. The module of claim 1 disposed adjacent to at least one additional said module, said at least one module comprising a shape selected from the group consisting of a circle, a triangle, a square, a rectangle, an oval, an octagon, and a hexagon.

19. The module of claim 1 disposed adjacent to at least one additional said module.

20. The module of claim 1 wherein said lightweight material is fibrous.

21. The module of claim 1 wherein said lightweight material is porous.

22. The module of claim 1 wherein said lightweight material is non-woven.

23. The module of claim 1 wherein said lightweight material is lofty.

24. The module of claim 1 wherein said inorganic material comprises foam.

25. The module of claim 24 wherein said foam is an open-cell foam.

26. The module of claim 1 wherein said organic material comprises at least one material selected from the group consisting of peat moss, humus and soil.

27. A method of covering a surface with a plant comprising:
providing at least one planting reservoir comprising:
a bottom;
a sidewall;
a planting matrix comprising a lightweight material providing structure for plant root growth; and
a planting medium comprising an organic material and an inorganic material comprising a capillary conducive medium; and
growing the plant in the reservoir.

28. The method of claim 27 further comprising connecting the reservoir to a water source.

29. The method of claim 27 further comprising disposing a lower reservoir grid in the reservoir.

30. The method of claim 29 further comprising removably disposing a secondary grid on the lower reservoir grid.

31. The method of claim 27 further comprising disposing the planting reservoir on a slanted surface.

32. The method of claim 27 further comprising draining water through a drainage hole disposed in the sidewall.

33. The method of claim 27 further comprising disposing planting reservoirs adjacently.

34. The method of claim 27 further comprising interlocking the planting reservoir to an adjacent planting reservoir.

35. The method of claim 34 further comprising water flow between planting reservoirs.

36. The method of claim 27 further comprising disposing a planting reservoir adjacent to an additional planting reservoir and interlocking the planting reservoirs, wherein at least one planting reservoir comprises a shape selected from the group consisting of a circle, a triangle, a square, a rectangle, an oval, an octagon, and a hexagon.

37. The method of claim 27 comprising disposing a planting reservoir on a roof.

38. The method of claim 27 comprising disposing a planting reservoir on a lid.

39. The method of claim 27 comprising disposing a planting reservoir on a ground surface.

40. The method of claim 27 comprising disposing a planting reservoir on a walking surface.

41. The method of claim 27 comprising disposing the planting reservoir on a planter.

42. The method of claim 27 comprising disposing a planting reservoir on a wall.
